(19) United States
(12) Patent Application Publication
(10) Pub. No.: US 2024/0312252 A1
(43) Pub. Date: Sep. 19, 2024

(54) ACTION RECOGNITION METHOD AND APPARATUS

(71) Applicant: JINGDONG TECHNOLOGY HOLDING CO., LTD., Beijing (CN)

(72) Inventors: Zhaofan QIU, Beijing (CN); Yingwei PAN, Beijing (CN); Ting YAO, Beijing (CN); Tao MEI, Beijing (CN)

(21) Appl. No.: 18/552,885

(22) PCT Filed: Mar. 30, 2022
(86) PCT No.: PCT/CN2022/083988

§ 371 Date: Sep. 27, 2023

(30) Foreign Application Priority Data
Apr. 9, 2021 (CN) 202110380638.2

(51) Int. Cl. G06V 40/20; G06T 7/70; G06V 10/25; G06V 10/44; G06V 10/762; G06V 20/40

(52) U.S. Cl. CPC G06V 40/20; G06T 7/70; G06V 10/25; G06V 10/44; G06V 10/762; G06V 20/49

(57) ABSTRACT

Disclosed in the present application are an action recognition method and apparatus. The method comprises: acquiring a video clip, and determining at least two target objects in the video clip; for each of the at least two target objects, connecting positions of the target object in various video frames of the video clip, so as to construct a spatiotemporal graph of the target object; dividing at least two spatiotemporal graphs, which are constructed for the at least two target objects, into a plurality of spatiotemporal graph subsets, and determining a finally selected subset from the plurality of spatiotemporal graph subsets; and determining an action category of the action between the target objects that is indicated by a relationship between the spatiotemporal graphs included in the finally selected subset as the action category of an action included in the video clip.

### CROSS-REFERENCE TO RELATED APPLICATION

This application is a national stage of International Application No. PCT/CN2022/083988, filed on Mar. 30, 2022, which claims the priority of Chinese Patent Application No. 202110380638.2, filed on Apr. 9, 2021. Both of the aforementioned applications are hereby incorporated by reference in their entireties.

### TECHNICAL FIELD

The present disclosure relates to the field of computer technology, and particularly to a method and apparatus for recognizing an action.

### BACKGROUND

Recognizing the actions of detected objects in videos is conducive to classifying the videos or recognizing the features of the videos. In the relevant technology, a method for recognizing actions of detected objects in the videos utilizes a recognition model trained based on deep learning methods to recognize actions in the videos, or recognizes actions in the videos based on the features of the actions appearing in the video pictures and the similarity between these features and a preset feature.

### SUMMARY

The present disclosure provides a method and apparatus for recognizing an action, an electronic device and a computer readable storage medium.

Some embodiments of the present disclosure provide a method for recognizing an action, including: acquiring a video clip and determining at least two target objects in the video clip; connecting, for each target object in the at least two target objects, positions of the target object in respective video frames of the video clip to construct a spatio-temporal graph of the target object; dividing at least two spatio-temporal graphs constructed for the at least two target objects into a plurality of spatio-temporal graph subsets, and determining a final subset from the plurality of spatio-temporal graph subsets; and determining an action category between target objects indicated by a relationship between spatio-temporal graphs included in the final subset as an action category of an action included in the video clip.

Some embodiments of the present disclosure provide an apparatus for recognizing an action, including: an acquisition unit, configured to acquire a video clip and determine at least two target objects in the video clip; a construction unit, configured to connect, for each target object in the at least two target objects, positions of the target object in respective video frames of the video clip to construct a spatio-temporal graph of the target object; a first determination unit, configured to divide at least two spatio-temporal graphs constructed for the at least two target objects into a plurality of spatio-temporal graph subsets, and determine a final subset from the plurality of spatio-temporal graph subsets; and a recognition unit, configured to determine an action category between target objects indicated by a relationship between spatio-temporal graphs included in the final subset as an action category of an action included in the video clip.

Embodiments of the present disclosure provide an electronic device, and the electronic device includes: one or more processors; and a storage apparatus configured to store one or more programs, where the one or more programs, when executed by the one or more processors, cause the one or more processors to implement the method for recognizing an action as described above.

Embodiments of the present disclosure provide a computer readable medium storing a computer program, where the program, when executed by a processor, implements the method for recognizing an action as described above.

It should be understood that the description in this section is not intended to identify key or critical features of the embodiments of the present disclosure, nor is it intended to limit the scope of the present disclosure. Other features of the present disclosure will become readily apparent from the following description.

### BRIEF DESCRIPTION OF THE DRAWINGS

The accompanying drawings are intended to provide a better understanding of the present disclosure and are not to be construed as limiting the present disclosure.

FIG. 1 is a diagram of an example system architecture in which embodiments of the present disclosure may be applied;

FIG. 2 is a flowchart of a method for recognizing an action according to an embodiment of the present disclosure;

FIG. 3 is a schematic diagram of a method for constructing a spatio-temporal graph in the method for recognizing an action according to an embodiment of the present disclosure;

FIG. 4 is a schematic diagram of a method for dividing a spatio-temporal graph subset in the method for recognizing an action according to an embodiment of the present disclosure;

FIG. 5 is a schematic diagram of the method for recognizing an action according to another embodiment of the present disclosure;

FIG. 6 is a schematic diagram of a method for dividing a spatio-temporal graph subset in the method for recognizing an action according to another embodiment of the present disclosure;

FIG. 7 is a flowchart of the method for recognizing an action according to yet another embodiment of the present disclosure;

FIG. 8 is a schematic structural diagram of an apparatus for recognizing an action according to an embodiment of the present disclosure;

FIG. 9 is a block diagram of an electronic device adapted to implement the method for recognizing an action according to embodiments of the present disclosure.

### DETAILED DESCRIPTION OF EMBODIMENTS

Example embodiments of the present disclosure are described below in combination with the accompanying drawings, and various details of the embodiments of the present disclosure are included in the description to facilitate understanding, and should be considered as exemplary only. Accordingly, it should be recognized by one of ordinary skill in the art that various changes and modifications may be made to the embodiments described herein without departing from the scope and spirit of the present disclosure. Also, for clarity and conciseness, descriptions of well-known functions and structures are omitted in the following description.

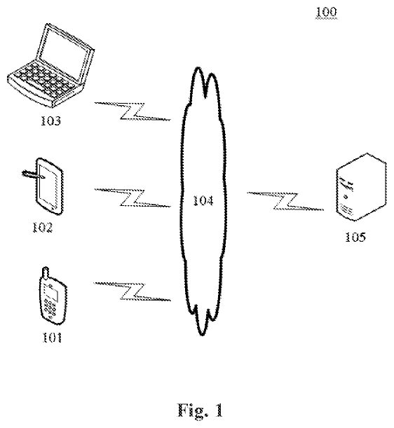

FIG. 1 illustrates an example system architecture 100 in which a method or apparatus for recognizing an action may be applied.

As shown in FIG. 1, the system architecture 100 may include terminal device(s) 101, 102, 103, a network 104, and a server 105. The network 104 serves as a medium providing a communication link between the terminal device(s) 101, 102, 103, and the server 105. The network 104 may include various types of connections, such as wired or wireless communication links, or fiber optic cables.

The user 110 may use the terminal device(s) 101, 102, 103 to interact with the server 105 via the network 104, to receive or send a message, etc. Various client applications, such as an image acquisition application, a video acquisition application, an image recognition application, a video recognition application, a playback application, a search application, and a financial application, may be installed on the terminal(s) 101, 102, 103.

The terminal device(s) 101, 102, 103 may be various electronic devices having a display screen and support for receiving a server message, including, but not limited to, a smartphone, a tablet computer, an electronic book reader, an electronic player, a laptop portable computer, a desktop computer, and the like.

The terminal device(s) 101, 102, 103 may be hardware or software. When being the hardware, the terminal device(s) 101, 102, 103 may be various electronic devices. When being the software, the terminal device(s) 101, 102, 103 may be installed on the above-listed electronic devices. The terminal device(s) 101, 102, 103 may be implemented as a plurality of pieces of software or a plurality of software modules (e.g., a plurality of software modules for providing a distributed service), or may be implemented as a single piece of software or a single software module, which is not specifically limited herein.

When the terminal(s) 101, 102, 103 are the hardware, an image acquisition device may be installed thereon. The image acquisition device may be various devices capable of acquiring an image, such as a camera, a sensor, or the like. The user 110 may acquire images of various scenarios by using the image acquisition devices on the terminal(s) 101, 102, 103.

The server 105 may acquire a video clip sent by the terminal(s) 101, 102, 103, and determine at least two target objects in the video clip; for each target object in the at least two target objects, connecting positions of the target object in respective video frames of the video clip to construct a spatio-temporal graph of the target object; divide the constructed at least two spatio-temporal graphs into a plurality of spatio-temporal graph subsets, and determine a final subset from the plurality of spatio-temporal graph subsets; and determine an action category between target objects indicated by a relationship between spatio-temporal graphs included in the final subset as an action category of an action included in the video clip.

It should be noted that the method for recognizing an action provided by embodiments of the present disclosure is generally performed by the server 105. Accordingly, the apparatus for recognizing an action is generally arranged in the server 105.

It should be understood that the number of the terminals, network, and server in FIG. 1 is only illustrative. Depending on the implementation needs, any number of terminals, networks, and servers may be employed.

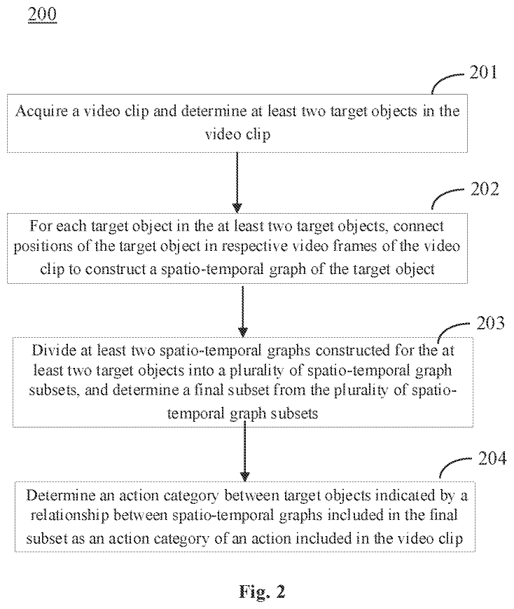

Further referring to FIG. 2, FIG. 2 illustrates a flow 200 of a method for recognizing an action according to an embodiment of the present disclosure, which includes the following steps.

Step 201, acquiring a video clip and determining at least two target objects in the video clip.

In this embodiment, an execution body (for example, the server 105 shown in FIG. 1) of the method for recognizing an action may acquire the video clip through a wired or wireless means and determine at least two target objects in the video clip. The target object may be a human, may be an animal, or may be any entity that may exist in a video image.

In this embodiment, respective target objects in the video clip may be recognized by using a trained target recognition model. Alternatively, target objects appearing in the video picture may be recognized by comparing and matching the video image with a preset pattern.

Step 202, for each target object in the at least two target objects, connecting positions of the target object in respective video frames of the video clip to construct a spatio-temporal graph of the target object.

In this embodiment, for each target object in the at least two target objects, the positions of the target object in the respective video frames of the video clip may be connected by line(s) to construct the spatio-temporal graph of the target object. The spatio-temporal graph refers to a graph spanning the video frames and is formed after the positions of the target object in the respective video frames of the video clip are connected by line(s).

In some alternative embodiments, the connecting positions of the target object in respective video frames of the video clip includes: representing the target object as rectangular boxes in the respective video frames; and connecting the rectangular boxes in the respective video frames according to a play order of the respective video frames.

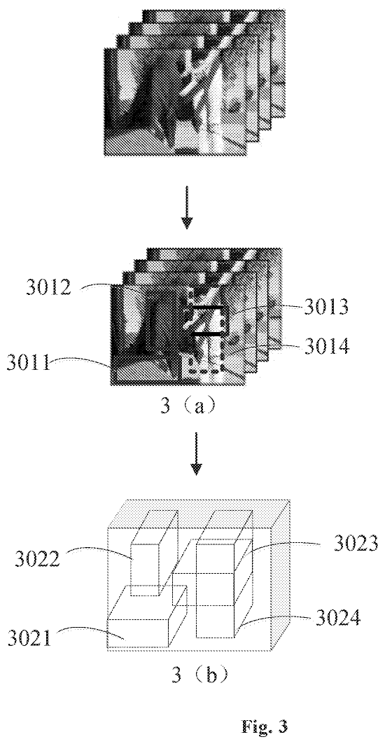

In these alternative embodiments, as shown in FIG. 3(a), the target object may be represented in the form of rectangular boxes (or candidate boxes generated after performing target recognition) in the respective video frames, and the rectangular boxes representing the target object in the respective video frames are connected in sequence according to the play order of the video frames, so as to form the spatio-temporal graph of the target object as shown in FIG. 3(b) of FIG. 3. Here, FIG. 3(a) illustrates four rectangular boxes representing the target objects of the platform 3011 at the bottom left corner, the horse back 3012, the brush 3013, and the person 3014, respectively, where the rectangular box representing the person is represented in the form of dotted lines only to distinguish it from the overlapping rectangular box of the brush. The spatio-temporal graph 3021, the spatio-temporal graph 3022, the spatio-temporal graph 3023, and the spatio-temporal graph 3024 in FIG. 3(b) of FIG. 3 represent the spatio-temporal graph of the platform 3011, the spatio-temporal graph of the horse back 3012, the spatio-temporal graph of the brush 3013, and the spatio-temporal graph of the person 3014, respectively.

In some alternative embodiments, the positions of the center points of the target object in the respective video frames may be connected according to the play order of the respective video frames to form a spatio-temporal graph of the target object.

In some alternative embodiments, the target object may be represented as a preset shape in the respective video frames, and the shapes representing the target object in the respective video frames are connected in sequence according to the play order of the video frames to form a spatio-temporal graph of the target object.

Step 203, dividing at least two spatio-temporal graphs constructed for the at least two target objects into a plurality of spatio-temporal graph subsets, and determining a final subset from the plurality of spatio-temporal graph subsets.

In this embodiment, the at least two spatio-temporal graphs constructed for the at least two target objects are divided into a plurality of spatio-temporal graph subsets, and a final subset is determined from the plurality of spatio-temporal graph subsets. The final subset may be a subset containing the largest number of spatio-temporal graphs among the plurality of spatio-temporal graph subsets. Alternatively, the final subset may be a subset whose similarities with all other spatio-temporal graph subsets are greater than a threshold when calculating similarities between every two spatio-temporal graph subsets. Alternatively, the final subset may be a spatio-temporal graph subset that contains spatio-temporal graphs in the center areas of the image.

In some alternative embodiments, the determining a final subset from the plurality of spatio-temporal graph subsets includes: determining a plurality of target subsets from the plurality of spatio-temporal graph subsets; and determining the final subset from the plurality of target subsets based on a similarity between each spatio-temporal graph subset in the plurality of spatio-temporal graph subsets and each target subset in the plurality of target subsets.

In these alternative embodiments, a plurality of target subsets may be first determined from the plurality of spatio-temporal graph subsets, the similarity between each spatio-temporal graph subset in the plurality of spatio-temporal graph subsets and each target subset in the plurality of target subsets is calculated, and the final subset may be determined from the plurality of target subsets based on a result of the similarity calculation.

Particularly, a plurality of target subsets may be first determined from the plurality of spatio-temporal graph subsets, the plurality of target subsets are subsets for representing a plurality of spatio-temporal graph subsets, and the plurality of target subsets are at least one target subset that is obtained by clustering the plurality of spatio-temporal graph subsets and may represent each category of the spatio-temporal graph subsets.

For each target subset, each spatio-temporal graph subset in the plurality of spatio-temporal graph subsets may be compared with the target subset, and a target subset with the largest number of matching spatio-temporal graph subsets may be determined as the final subset. For example, there are a target subset A, a target subset B, and a spatio-temporal graph subset 1, a spatio-temporal graph subset 2, and a spatio-temporal graph subset 3, and it is predetermined that two spatio-temporal graph subsets are matching if a similarity between the spatio-temporal graph subsets is greater than 80%. If the similarity between the spatio-temporal graph subset 1 and the target subset A is 85%, the similarity between the spatio-temporal graph subset 1 and the target subset B is 20%, the similarity between the spatio-temporal graph subset 2 and the target subset A is 65%, the similarity between the spatio-temporal graph subset 2 and the target subset B is 95%, the similarity between the spatio-temporal graph subset 3 and the target subset A is 30%, and the similarity between the spatio-temporal graph subset 3 and the target subset B is 90%, it may be determined that in all the spatio-temporal graph subsets, the number of spatio-temporal graph subsets matching the target subset A is 1, and the number of spatio-temporal graph subsets matching the target subset B is 2. Then the target subset B may then be determined as the final subset.

These alternative embodiments first determine target subsets, and determine the final subset from the plurality of target subsets based on the similarity between each spatio-temporal graph subset in the plurality of spatio-temporal graph subsets and each target subset in the plurality of target subsets, which may improve the accuracy of determining the final subset.

Step 204, determining an action category between target objects indicated by a relationship between spatio-temporal graphs included in the final subset as an action category of an action included in the video clip.

In this embodiment, since the spatio-temporal graph is used to represent the spatial positions of the target object in successive video frames, the spatio-temporal graph subset contains the position relationship(s) or shape relationship(s) between various combinable spatio-temporal graphs, and therefore, the spatio-temporal graph subset may be used to represent a pose relationship between the target objects. The final subset is a subset that is selected from the plurality of spatio-temporal graph subsets and may represent a global spatio-temporal graph subset. Therefore, a position relationship or a shape relationship between spatio-temporal graphs included in the final subset may be used to represent a global pose relationship between target objects, that is, an action category represented by the pose relationship between the target objects and indicated by the relationship between the spatio-temporal graphs included in the final subset may be used as the action category of the action included in the video clip.

The method for recognizing an action provided by this embodiment: acquires the video clip and determines at least two target objects in the video clip; connects, for each target object in the at least two target objects, the positions of the target object in the respective video frames of the video clip to construct the spatio-temporal graph of the target object; divides the at least two spatio-temporal graphs constructed for the at least two target objects into the plurality of spatio-temporal graph subsets, and determines the final subset from the plurality of spatio-temporal graph subsets; and determines the action category between the target objects indicated by the relationship between the spatio-temporal graphs included in the final subset as the action category of the action included in the video clip. The pose relationship between the target objects may be represented by the relationship between the spatio-temporal graphs thereof, and the action category between the target objects indicated by the relationship between the spatio-temporal graphs included in the final subset (the final subset may represent a global spatio-temporal graph subset) may be determined as the action category of the action included in the video clip, so that the accuracy of recognizing the action in the video may be improved.

Alternatively, the positions of the target object in the respective video frames of the video clip are determined based on the following method: acquiring a position of the target object in a starting frame of the video clip, using the starting frame as a current frame, and determining the positions of the target object in the respective video frames through multi-rounds of an iterative operation. The iterative operation includes: inputting the current frame into a pre-trained prediction model to predict a position of the target object in a next frame of the current frame, and using, in response to determining that the next frame of the current frame is not an end frame of the video clip, the next frame of the current frame in a current round of the iterative operation as a current frame of a next round of iterative operation; in response to determining that the next frame of the current frame is the end frame of the video clip, stopping the iterative operation.

In this embodiment, the starting frame of the video clip may be first acquired, the position of the target object in the starting frame is acquired, the starting frame is used as the current frame, and the positions of the target object in the respective frames of the video clip is determined through the multi-rounds of the iterative operation. The iterative operation includes that: the current frame is input into the pre-trained prediction model to predict the position of the target object in the next frame of the current frame, and if it is determined that the next frame of the current frame is not the end frame of the video clip, the next frame of the current frame in the current round of the iterative operation is used as the current frame of the next round of the iterative operation, so as to continue to predict the positions of the target object in the next video frames through the position of the target object in the corresponding video frame predicted in the current round of the iterative operation. If it is determined that the next frame of the current frame is the end frame of the video clip, the positions of the target object in the respective frames of the video clip are predicted, and the iterative operation may be stopped.

The above prediction process is that: when the position of the target object in the first frame of the video clip is known, the position of the target object in the second frame is predicted through the prediction model, and the position of the target object in the third frame is predicted according to the obtained position of the target object in the second frame, whereby the position of the target object in a next frame is predicted through the position of the target object in the current frame until the positions of the target object in all the video frames of the video clip are obtained.

Particularly, if a length of the video clip is T frames, first, a candidate box (i.e., a rectangular box for representing a target object) of a person or an object in a first frame of the video clip is detected by using a pre-trained neural network model (e.g., Faster Region-Convolutional Neural Networks), and top M candidate boxes B₁={b₁^{m}|m=1, . . . , M} with highest scores are reserved. Similarly, based on a candidate box set Bₜ of a t-th frame, the prediction model generates a candidate box set Bₜ₊₁ for a (t+1)-th frame, that is, based on any candidate box in the t-th frame, the prediction model estimates a motion trend in a next frame based on visual features at identical positions in the t-th frame and the (t+1)-th frame.

Then, the visual features Fₜ^{m} and Fₜ₊₁^{m} at the identical positions (e.g., positions of the m-th candidate box) in the t-th frame and (t+1)-th frames are obtained through a pooling operation.

Finally, a compact bilinear pooling (CBP) operation is used to capture a pairwise correlation between the two visual features and simulate a spatial interaction between adjacent frames:

$$CBP ( {F}_{t}^{m} , {F}_{t + 1}^{m} ) = {\sum }_{j = 1}^{N} {\sum }_{k = 1}^{N} 〈 ϕ ( {F}_{t , j}^{m} ) , ϕ ( {F}_{t + 1 , k}^{m} ) 〉 \qquad ( 1 )$$

where N is the number of local descriptors, ϕ(⋅) is a low-dimensional mapping function, and <⋅> is a second-order polynomial kernel. Finally, an output feature of a CBP layer is input to a pre-trained regression model/regression layer, to obtain bₜ₊₁^{m} predicted based on a motion trend of bₜ^{m} and output by the regression layer. Thus, by estimating a motion trend of each candidate box, a set of candidate boxes in subsequent frames may be obtained, and these candidate boxes are connected into a spatio-temporal graph.

This embodiment predicts the positions of a target object in respective video frames based on the position of the target object in the starting frame of the video clip, instead of directly recognizing the positions of the target object by using the respective video frames in a known video clip, so that the problem that the recognition result may not truly reflect the actual position of the target object under the mutual action is avoided (the problem may be due to the occlusion of the target object in a certain video frame caused by the mutual action between the target objects), so that the accuracy of predicting the positions of the target object in the video frames may be improved.

Alternatively, the dividing at least two spatio-temporal graphs constructed for the at least two target objects into a plurality of spatio-temporal graph subsets includes: dividing adjacent spatio-temporal graphs in the at least two spatio-temporal graphs into a same spatio-temporal graph subset.

In this embodiment, a method for the dividing at least two spatio-temporal graphs constructed for the at least two target objects into a plurality of spatio-temporal graph subsets may be: dividing the adjacent spatio-temporal graphs in the at least two spatio-temporal graphs into the same spatio-temporal graph subset.

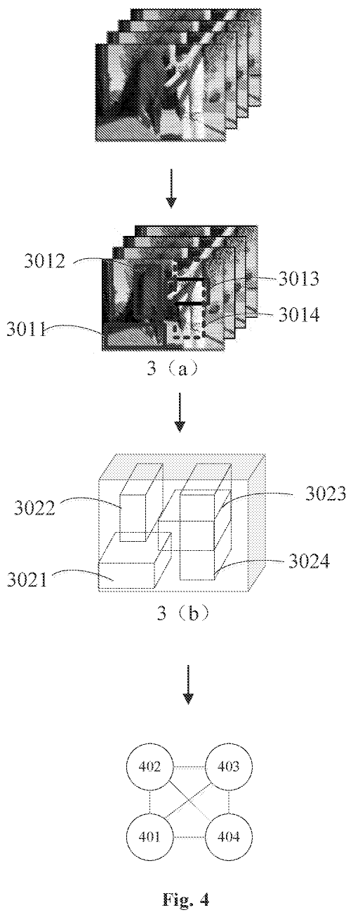

For example, as shown in FIG. 4, the respective spatio-temporal graphs in FIG. 3(b) of FIG. 3 may be represented by nodes, that is, the spatio-temporal graph 3021 is represented by the node 401, the spatio-temporal graph 3022 is represented by the node 402, the spatio-temporal graph 3023 is represented by the node 403, and the spatio-temporal graph 3024 is represented by the node 404. The adjacent spatio-temporal graphs may be divided into a same spatio-temporal graph subset. For example, the node 401 and the node 402 may be divided into a same spatio-temporal graph subset, the node 402 and the node 403 may be divided into a same spatio-temporal graph subset, the node 401, the node 402 and the node 403 may be divided into a same spatio-temporal graph subset, the node 401, the node 402, the node 403, the node 404 may be divided into a same spatio-temporal graph subset, or the like.

This embodiment divides the adjacent spatio-temporal graphs into a same spatio-temporal graph subset, which is beneficial to dividing the spatio-temporal graphs representing the target objects having a relationship of mutual actions into a same spatio-temporal graph subset. The determined respective spatio-temporal graph subsets may comprehensively represent the respective actions of the target objects in the video clip, thereby improving accuracy of recognizing the actions.

It should be noted that, in order to explicitly describing the method for recognizing the action category of the action included in the video clip based on the spatio-temporal graphs of the target objects in the video clip, and in order to facilitate the clear expression of the operations of the method, the embodiment of the present disclosure represents the spatio-temporal graph in the form of nodes. In the practical application of the method described in the present disclosure, the spatio-temporal graphs may not be represented as the nodes, but the spatio-temporal graph may be directly used to perform the various operations.

It should be noted that the dividing a plurality of nodes into a sub-graph described in the embodiments of the present disclosure means dividing the spatio-temporal graphs represented by the nodes into a spatio-temporal graph subset. A node feature of the node is a feature vector of a spatio-temporal graph represented by the node, and a feature of an edge between nodes is a relationship feature between the spatio-temporal graphs represented by the nodes. A sub-graph composed of at least one node is a spatio-temporal graph subset composed of the spatio-temporal graph(s) represented by the at least one node.

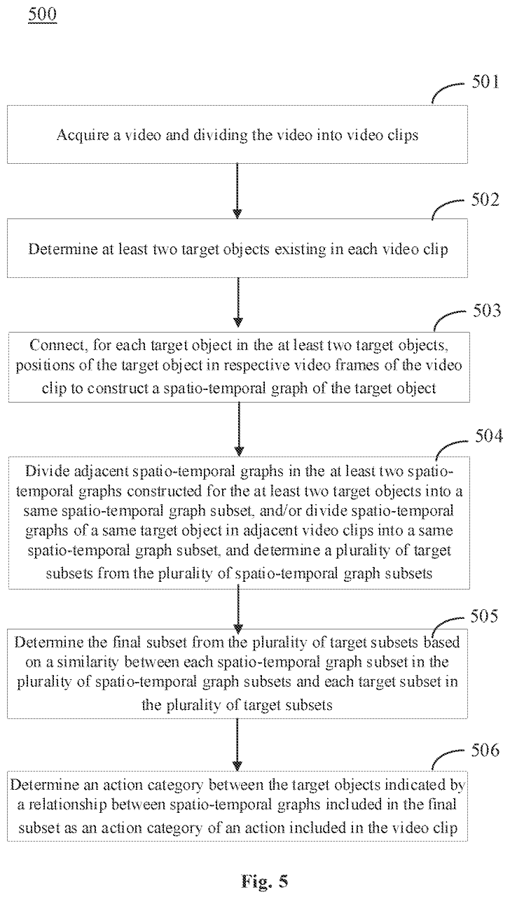

Further referring to FIG. 5, FIG. 5 illustrates a flowchart 500 of the method for recognizing an action according to another embodiment of the present disclosure, and includes the following steps.

Step 501, acquiring a video and dividing the video into video clips.

In this embodiment, an execution body (for example, the server 105 shown in FIG. 1) of the method for recognizing an action may acquire a complete video by a wired or wireless means, and cut out the video clips from the acquired complete video through a video clipation method or a video clip interception method.

Step 502, determining at least two target objects existing in each video clip.

In this embodiment, the target objects existing in the respective video clips may be recognized by using a trained target recognition model. Alternatively, the target objects appearing in the video images may be recognized by comparing and matching the video images with a preset pattern.

Step 503, connecting, for each target object of the at least two target objects, positions of the target object in respective video frames of the video clip to construct a spatio-temporal graph of the target object.

Step 504, dividing adjacent spatio-temporal graphs in the at least two spatio-temporal graphs constructed for the at least two target objects into a same spatio-temporal graph subset, and/or dividing spatio-temporal graphs of a same target object in adjacent video clips into a same spatio-temporal graph subset, and determining a plurality of target subsets from the plurality of spatio-temporal graph subsets.

In this embodiment, the adjacent spatio-temporal graphs in the at least two spatio-temporal graphs constructed for the at least two target objects may be divided into a same spatio-temporal graph subset, and the spatio-temporal graphs of the same target object in the adjacent video clips may be divided into a same spatio-temporal graph subset, and the plurality of target subsets may be determined from the plurality of spatio-temporal graph subsets.

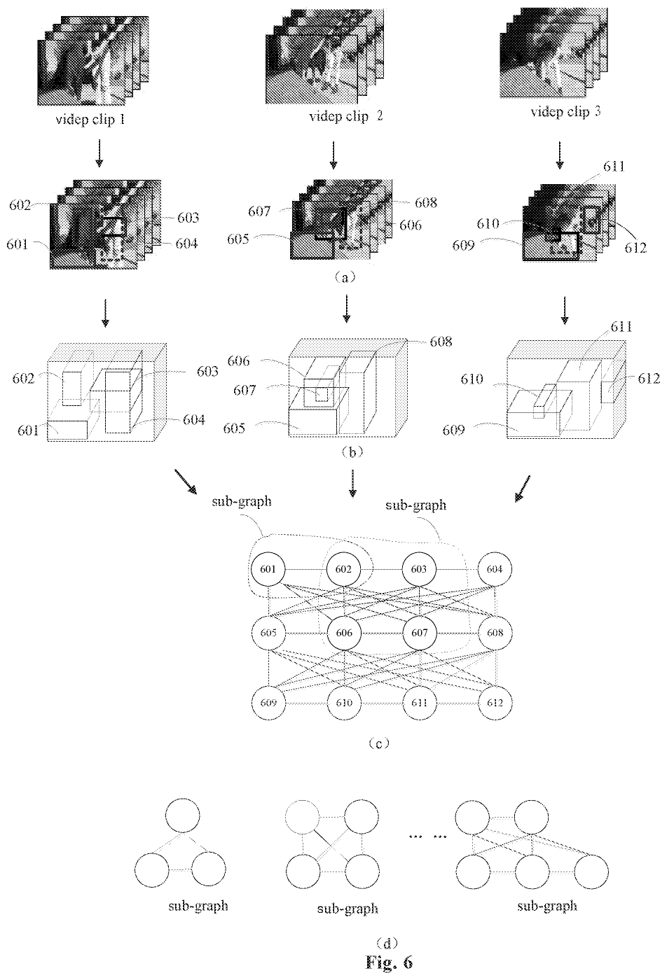

For example, as shown in (a) of FIG. 6, the video clip 1, the video clip 2, and the video clip 3 are extracted from the complete video, and the spatio-temporal graphs of the target objects in respective video clips as shown in (b) of FIG. 6 are constructed. The constructed spatio-temporal graph of the target object A (platform) in the video clip 1 is 601, the constructed spatio-temporal graph of the target object A (platform) in the video clip 2 is 605, and the constructed spatio-temporal graph of the target object A (platform) in the video clip 3 is 609. The constructed spatio-temporal graph of the target object B (horse back) in the video clip 1 is 602, the constructed spatio-temporal graph of the target object B (horse back) in the video clip 2 is 606, and the target object B is not recognized in the video clip 3. The constructed spatio-temporal graph of the target object C (brush) in the video clip 1 is 603, the constructed spatio-temporal graph of the target object C (brush) in the video clip 2 is 607, and the constructed spatio-temporal graph of the target object C (brush) in the video clip 3 is 610. The constructed spatio-temporal graph of the target object D (the person) in the video clip 1 is 604, the constructed spatio-temporal graph of the target object D (the person) in the video clip 2 is 608, and the constructed spatio-temporal graph of the target object D (the person) in the video clip 3 is 611. A new target object (background landscape) 612 appears in the video clip 3. In this example, each spatio-temporal graph is a spatio-temporal graph of the target object with the same sequence number in the corresponding video clip (for example, in the video clip 1, the spatio-temporal graph 601 in (b) of FIG. 6 is a spatio-temporal graph of the target object 601 in (a) of FIG. 6).

The spatio-temporal graphs described above are represented in the form of nodes to construct a complete node diagram of the video as shown in (c) of FIG. 6, where each node represents a spatio-temporal graph with the same sequence number (for example, the node 601 represents the spatio-temporal graph 601).

In (c) of FIG. 6, the node 601, the node 605, and the node 606 may be divided into a same sub-graph, and the node 603, the node 604, the node 607, and the node 608 may be divided into a same sub-graph, and the like.

Step 505, determining the final subset from the plurality of target subsets based on a similarity between each spatio-temporal graph subset in the plurality of spatio-temporal graph subsets and each target subset in the plurality of target subsets.

Step 506, determining an action category between the target objects indicated by a relationship between spatio-temporal graphs included in the final subset as an action category of an action included in the video clip.

The description of step 503, step 505, and step 506 in this embodiment is consistent with the description of step 202, step 204, and step 205, and details are not described herein.

The method for recognizing an action provided by the embodiments: divides the acquired video into respective video clips, determines the respective target objects existing in the video clips, constructs the spatio-temporal graph of a target object belonging to a video clip, divides the adjacent spatio-temporal graphs into a same spatio-temporal graph subset, and/or divides the spatio-temporal graphs of the same target object in the adjacent video clips into a same spatio-temporal graph subset, and determines the plurality of target subsets from the plurality of spatio-temporal graph subsets. Since the adjacent spatio-temporal graphs in the same video clip reflect the position relationship between target objects, and the spatio-temporal graphs of the same target object in the adjacent video clips may reflect the changing state of the positions of the target object in the video playing process, by dividing the adjacent spatio-temporal graphs in the same video clip into a same spatio-temporal graph subset, and/or dividing the spatio-temporal graphs of the same target object in the adjacent video clips into a same spatio-temporal graph subset, it is conducive to dividing the spatio-temporal graphs representing the changes of the actions of the target objects into the same spatio-temporal graph subsets, and the determined respective spatio-temporal graph subsets may comprehensively represent the respective actions of the target objects in the video clips, thereby improving the accuracy of recognizing the actions.

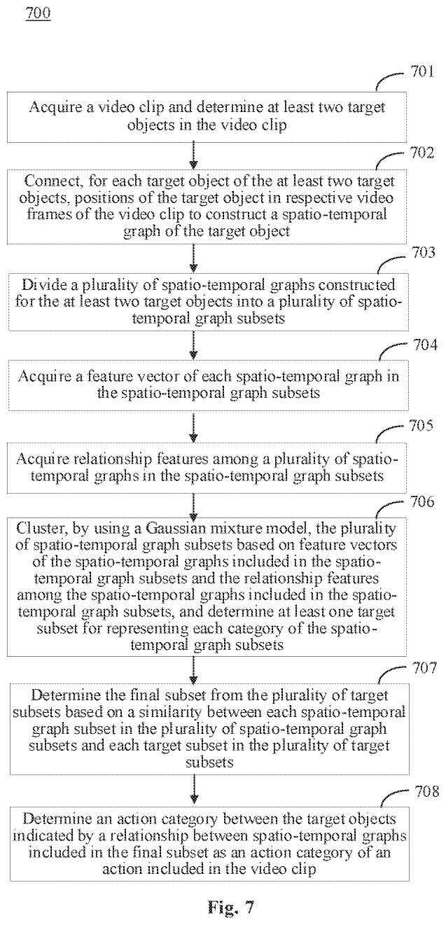

Further referring to FIG. 7, FIG. 7 illustrates a flowchart 700 of the method for recognizing an action according to yet another embodiment of the present disclosure, and includes the following steps.

Step 701, acquiring a video clip and determining at least two target objects in the video clip.

Step 702, connecting, for each target object of the at least two target objects, positions of the target object in respective video frames of the video clip to construct a spatio-temporal graph of the target object.

Step 703, dividing a plurality of spatio-temporal graphs constructed for the at least two target objects into a plurality of spatio-temporal graph subsets.

In this embodiment, at least two spatio-temporal graphs constructed for the at least two target objects are divided into a plurality of spatio-temporal graph subsets.

Step 704, acquiring a feature vector of each spatio-temporal graph in the spatio-temporal graph subsets.

In this embodiment, the feature vector of each spatio-temporal graph in the spatio-temporal graph subsets may be acquired. Particularly, a video clip including the spatio-temporal graphs is input into a pre-trained neural network model to obtain the feature vector of each spatio-temporal graph output by the neural network model. The neural network model may be a recurrent neural network, a deep neural network, a deep residual neural network, or the like.

In some alternative embodiments, the acquiring a feature vector of each spatio-temporal graph in the spatio-temporal graph subsets includes: acquiring spatial feature and visual feature of each spatio-temporal graph by using a convolutional neural network.

In these alternative embodiments, the feature vector of a spatio-temporal graph includes the spatial feature of the spatio-temporal graph and the visual feature of the spatio-temporal graph. The video clip including the spatio-temporal graph may be input into a pre-trained convolutional neural network to obtain a T*W*H*D-dimensional convolutional feature output by the convolutional neural network, where T represents a convolutional time dimension, W represents a width of the convolutional feature, H represents a height of the convolutional feature, and D represents the number of channels of the convolutional feature. In this embodiment, in order to preserve the time granularity of the original video, the convolutional neural network may have no down-sampling layer in the time dimension, that is, the spatial features of the video clip are not down-sampled. For the spatial coordinates of a bounding box of a spatio-temporal graph in each frame, a pooling operation is performed on the convolutional feature output by the convolutional neural network to obtain the visual feature fᵥ^{visual} of the spatio-temporal graph. The spatial position of the bounding box of the spatio-temporal graph in each frame (for example, a four-dimensional vector \hat{f}ᵥ^{coord} of center point coordinates of the spatio-temporal graph with a shape of a rectangular box, and a length, width and height of the rectangular box) is input into a multi-layer perceptron, and an output of the multi-layer perceptron is used as a spatial feature fᵥ^{coord} of the spatio-temporal graph.

Step 705, acquiring a relationship feature among a plurality of spatio-temporal graphs in the spatio-temporal graph subsets.

In this embodiment, relationship feature(s) among a plurality of spatio-temporal graphs in the spatio-temporal graph subsets are acquired. Here, a relationship feature characterizes a similarity between features and/or a positional relationship between spatio-temporal graphs.

In some alternative embodiments, the acquiring a relationship feature among a plurality of spatio-temporal graphs in the spatio-temporal graph subsets includes: determining, for every two spatio-temporal graphs of the plurality of spatio-temporal graphs, a similarity between the two spatio-temporal graphs based on visual features of the two spatio-temporal graphs; and determining a position change feature between the two spatio-temporal graphs based on spatial features of the two spatio-temporal graphs.

In these alternative embodiments, the relationship feature between the spatio-temporal graphs may include a similarity between the spatio-temporal graphs or a position change feature between the spatio-temporal graphs. For every two spatio-temporal graphs in the plurality of spatio-temporal graphs, the similarity between the two spatio-temporal graphs may be determined based on the similarity between the visual features of the two spatio-temporal graphs. Particularly, the similarity between the two spatio-temporal graphs may be calculated by the following formula (2):

$${f}_{{e}_{ij}}^{sem} = φ {( {f}_{{υ}_{i}}^{visual} )}^{T} φ ( {f}_{{υ}_{j}}^{visual} ) \qquad ( 2 )$$

where fₑ_{ᵢⱼ}^{sem} represents the similarity between the spatio-temporal graph vᵢ and the spatio-temporal graph vⱼ, fᵥ_{ᵢ}^{visual} and fᵥ_{ⱼ}^{visual} represent the visual features of the spatio-temporal graph vᵢ and the spatio-temporal graph vⱼ, respectively, and [symbol] (⋅) represents the feature conversion function.

In these alternative embodiments, the position change information between the two spatio-temporal graphs may be determined according to the spatial features of the two spatio-temporal graphs, and particularly, the position change information between the two spatio-temporal graphs may be calculated by the following formula (3):

$${\hat{f}}_{{e}_{ij}}^{coord} = {\hat{f}}_{{υ}_{i}}^{coord} - {\hat{f}}_{{υ}_{j}}^{coord} \qquad ( 3 )$$

where, \hat{f}ₑ_{ᵢⱼ}^{coord} represents the position change information between the spatio-temporal graph vᵢ and the spatio-temporal graph vⱼ, and \hat{f}ᵥ_{ᵢ}^{coord} and \hat{f}ᵥ_{ᵢ}^{coord} represent the spatial features of the spatio-temporal graph vᵢ and the spatio-temporal graph vⱼ, respectively. After the position change information is input to the multi-layer perceptron, the position change feature between the spatio-temporal graph vᵢ and the spatio-temporal graph vⱼ output by the multi-layer perceptron may be obtained.

Step 706, clustering, by using a Gaussian mixture model, the plurality of spatio-temporal graph subsets based on feature vectors of the spatio-temporal graphs included in the spatio-temporal graph subsets and the relationship feature(s) among the spatio-temporal graphs included in the spatio-temporal graph subsets, and determining at least one target subset for representing each category of the spatio-temporal graph subsets.

In this embodiment, the plurality of spatio-temporal graph subsets may be clustered by using the Gaussian mixture model based on the feature vectors of the spatio-temporal graphs included in the spatio-temporal graph subsets and the relationship feature(s) among the spatio-temporal graphs included in the spatio-temporal graph subsets, and each target subset for representing each category of the spatio-temporal graph subsets may be determined.

Particularly, the node graph shown in (c) of FIG. 6 may be decomposed into sub-graphs of a plurality of scales shown in (d) of FIG. 6, and the number of nodes included in the sub-graphs of different scales is different. For the sub-graphs of each scale, the node features of the nodes included in the sub-graphs (the node features of the nodes are feature vectors of the spatio-temporal graphs represented by the nodes) and the line features between nodes (the line feature between the two nodes is the relationship feature between the two spatio-temporal graphs represented by the two nodes) may be input into a preset Gaussian mixture model, and the sub-graphs of this scale are clustered by using the Gaussian mixture model, and a target sub-graph may be determined from each category of sub-graphs, where the target sub-graph may represent this category of sub-graphs. When the Gaussian mixture model is used to cluster sub-graphs of the same scale, the k Gaussian kernels output by the Gaussian mixture model are k target sub-graphs.

It should be understood that the spatio-temporal graphs represented by the nodes included in the target sub-graph constitutes the target spatio-temporal graph subset. The target spatio-temporal graph subset may be understood as a subset that may represent a spatio-temporal graph subset of this scale, and the action category between target objects indicated by the relationship between the spatio-temporal graphs included in target spatio-temporal graph subset may be understood as the representative action category at this scale. Thus, the k target subsets may be considered as a standard pattern of action categories corresponding to sub-graphs of the scale.

Step 707, determining the final subset from the plurality of target subsets based on a similarity between each spatio-temporal graph subset in the plurality of spatio-temporal graph subsets and each target subset in the plurality of target subsets.

In this embodiment, the final subset may be determined from the plurality of target subsets based on the similarity between each spatio-temporal graph subset in the plurality of spatio-temporal graph subsets and each target subset in the plurality of target subsets.

Particularly, for each sub-graph shown in (d) of FIG. 6, the blending weight of the sub-graph is first obtained by the following formula:

$$α = MLP ( x ; θ ) , \qquad ( 4 )$$

$$\hat{γ} = Softmax ( α ) ,$$

where x represents a feature of the sub-graph x, and x contains a node feature of each node in the sub-graph x and a line feature between the nodes. α=MLP (x; θ) represents that x is input into a multi-layer perceptron with a parameter of θ, and thereafter, an output of the multi-layer perceptron is calculated by a normalized exponential softmax function, and a K-dimensional vector [symbol] for representing the blending weight of the sub-graph is obtained.

After obtaining the blending weights of N sub-graphs belonging to the same action category through formula (4), the parameters of the k-th (1≤k≤K) Gaussian kernel in the Gaussian Mixture Model may be calculated by the following formulas:

$${\hat{ϕ}}_{k} = {\sum }_{n = 1}^{N} \frac{{\hat{γ}}_{nk}}{N} \qquad ( 5 )$$

$${\hat{μ}}_{k} = \frac{{\sum }_{n = 1}^{N} {\hat{γ}}_{nk} {x}_{n}}{{\sum }_{n = 1}^{N} {\hat{γ}}_{nk}} \qquad ( 6 )$$

$${\hat{\sum }}_{k} = \frac{{\sum }_{n = 1}^{N} {\hat{γ}}_{nk} ( {x}_{n} - {\hat{μ}}_{k} ) {( {x}_{n} - {\hat{μ}}_{k} )}^{T}}{{\sum }_{n = 1}^{N} {\hat{γ}}_{nk}} \qquad ( 7 )$$

where \vec{ϕ}ₖ, \hat{μ}ₖ, \hat{Σ}ₖ are the weight, the mean value, and the covariance of the k-th Gaussian kernel, respectively, and [symbol] ₙₖ represents the vector of the blending weight of the n-th sub-graph in the k-th dimension. After obtaining the parameters of all Gaussian kernels, the probability p(x) that any sub-graph x belongs to the action category corresponding to the target subset (i.e., the similarity between any sub-graph x and the target subset) may be calculated by formula (8):

$$p ( x ) = {\sum }_{k = 1}^{K} {\hat{ϕ}}_{k} \frac{exp ( - \frac{1}{2} {( x - {\hat{μ}}_{k} )}^{T} \text{?} ( x - {\hat{μ}}_{k} ) )}{\sqrt{\vert 2 π {\hat{\sum }}_{k} \vert}} \qquad ( 8 )$$

$$\text{?} \text{indicates text missing or illegible when filed}$$

where |⋅| represents the determinant of a matrix.

In this embodiment, a batch loss function containing N sub-graphs at each scale may be defined as follows:

$$ℒ ( θ ) = - \frac{1}{N} {\sum }_{n = 1}^{N} log p ( {x}_{n} ) + λ R ( \hat{\sum } ) \qquad ( 9 )$$

$$where$$

$$R ( \text{?} ) = {\sum }_{k = 1}^{K} \text{?} \frac{1}{\text{?}} \qquad ( 10 )$$

$$\text{?} \text{indicates text missing or illegible when filed}$$

where, p(χₙ) is the prediction probability of the sub-graph xₙ, and R(\hat{Σ}) is the constraint function of the covariance matrix \hat{Σ}, used to constrain the diagonal values of \hat{Σ} to converge to a reasonable solution rather than 0. λ is a weight parameter for balancing the front and back parts of formula (9), and may be set based on requirements (e.g., may be set to 0.05). Since each operation in the Gaussian mixture layer is differentiable, the gradient may be backpropagated from the Gaussian mixture layer to the feature extraction network to optimize the entire network framework in an end-to-end manner.

In this embodiment, after obtaining the probability that any sub-graph x belongs to each action category through equation (8), for each action category, the mean value of the probabilities of the sub-graphs belonging to the action category may be used as the score of the action category, and the action category with the highest score may be used as the action category of the action included in the video.

Step 708, determining an action category between the target objects indicated by a relationship between spatio-temporal graphs included in the final subset as an action category of an action included in the video clip.

The description of step 701, step 702, and step 708 in this embodiment is consistent with the description of step 201, step 202, and step 204, and details are not described herein.

According to the method for recognizing an action provided by this embodiment, the plurality of spatio-temporal graph subsets are clustered by using the Gaussian mixture model based on the feature vectors of the spatio-temporal graphs included in the spatio-temporal graph subsets and the relationship features among the spatio-temporal graphs included in the spatio-temporal graph subsets. It may cluster the plurality of spatio-temporal graph subsets based on the feature vectors of the spatio-temporal graphs included in the spatio-temporal graph subsets and the relationship features among the spatio-temporal graphs included in the spatio-temporal graph subsets, as well as the presented normal distribution curve, even when the clustering category is unknown, which can improve clustering efficiency and clustering accuracy.

In some alternative implementations of the embodiments described in combination with FIG. 7, for each target subset in the plurality of target subsets, the determining a final subset based on a similarity between each spatio-temporal graph subset and the target subset includes: acquiring, for each target subset in the plurality of target subsets, a similarity between each spatio-temporal graph subset and the target subset; determining a maximum similarity in the similarity between each spatio-temporal graph subset and each target subset as a score of each target subset; and determining a target subset with a highest score in the plurality of target subsets as the final subset.

In this embodiment, for each target subset in the plurality of target subsets, the similarity between each spatio-temporal graph subset and the target subset may be obtained, the maximum similarity in all the similarities is taken as the score of the target subset, and the target subset with the highest score is determined as the final subset for all the target subsets.

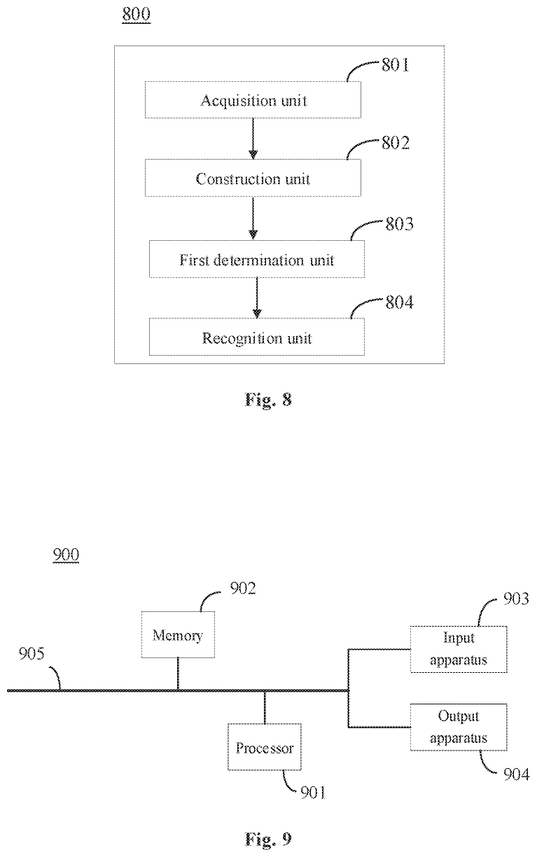

Further referring to FIG. 8, as an implementation of the method shown in the above drawings, the present disclosure provides an embodiment of an apparatus for recognizing an action. The embodiment of the apparatus corresponds to the embodiment of the method shown in FIG. 2, 5 or 7. The apparatus may be applied in various electronic devices.

As shown in FIG. 8, an apparatus 800 for recognizing an action of this embodiment includes: an acquisition unit 801, a construction unit 802, a first determination unit 803, and a recognition unit 804. The acquisition unit is configured to acquire a video clip and determine at least two target objects in the video clip; the construction unit is configured to connect, for each target object in the at least two target objects, positions of the target object in respective video frames of the video clip to construct a spatio-temporal graph of the target object; the first determination unit is configured to divide at least two spatio-temporal graphs constructed for the at least two target objects into a plurality of spatio-temporal graph subsets, and determine a final subset from the plurality of spatio-temporal graph subsets; and the recognition unit is configured to determine an action category between target objects indicated by a relationship between spatio-temporal graphs comprised in the final subset as an action category of an action comprised in the video clip.

In some embodiments, the positions of the target object in the respective video frames of the video clip are determined by: acquiring a position of the target object in a starting frame of the video clip, using the starting frame as a current frame, and determining the positions of the target object in the respective video frames through multi-rounds of an iterative operation; and the iterative operation includes: inputting the current frame into a pre-trained prediction model to predict a position of the target object in a next frame of the current frame, and using, in response to determining that the next frame of the current frame is not an end frame of the video clip, the next frame of the current frame in a current round of the iterative operation as a current frame of a next round of the iterative operation; in response to determining that the next frame of the current frame is the end frame of the video clip, stopping the iterative operation.

In some embodiments, the construction unit includes: a construction module, configured to represent the target object as rectangular boxes in the respective video frames; and a connection module, configured to connect the rectangular boxes in the respective video frames according to a play order of the respective video frames.

In some embodiments, the first determination unit includes: a first determination module, configured to divide adjacent spatio-temporal graphs in the at least two spatio-temporal graphs into a same spatio-temporal graph subset.

In some embodiments, the acquisition unit includes: a first acquisition module, configured to acquire a video and divide the video into video clips; and the apparatus includes: a second determination module, configured to divide spatio-temporal graphs of a same target object in adjacent video clips into a same spatio-temporal graph subset.

In some embodiments, the first determination unit includes: a first determination subunit, configured to determine a plurality of target subsets from the plurality of spatio-temporal graph subsets; and a second determination unit, configured to determine the final subset from the plurality of target subsets based on a similarity between each spatio-temporal graph subset in the plurality of spatio-temporal graph subsets and each target subset in the plurality of target subsets.

In some embodiments, the apparatus for recognizing an action includes: a second acquisition module, configured to acquire a feature vector of each spatio-temporal graph in the spatio-temporal graph subsets; and a third acquisition module, configured to acquire a relationship feature among a plurality of spatio-temporal graphs in the spatio-temporal graph subsets; and the first determination unit includes: a clustering module, configured to cluster, by using a Gaussian mixture model, the plurality of spatio-temporal graph subsets based on feature vectors of the spatio-temporal graphs comprised in the spatio-temporal graph subsets and the relationship features among the spatio-temporal graphs comprised in the spatio-temporal graph subsets, and determine at least one target subset for representing each category of the spatio-temporal graph subsets.

In some embodiments, the second acquisition module includes: a convolution module, configured to acquire a spatial feature and a visual feature of each spatio-temporal graph by using a convolutional neural network.

In some embodiments, the third acquisition module includes: a similarity calculation module, configured to determine, for every two spatio-temporal graphs in the plurality of spatio-temporal graphs, a similarity between the two spatio-temporal graphs based on visual features of the two spatio-temporal graphs; and a position change calculation module, configured to determine a position change feature between the two spatio-temporal graphs based on spatial features of the two spatiotemporal graphs.

In some embodiments, the second determination unit includes: a matching module, configured to acquire, for each target subset in the plurality of target subsets, a similarity between each spatio-temporal graph subset and each target subset; a scoring module, configured to determine a maximum similarity in similarities between the spatio-temporal graph subsets and the target subset as a score of the target subset; and a screening module, configured to determine a target subset with a highest score in the plurality of target subsets as the final subset.

The units in the apparatus 800 correspond to the steps in the method described with reference to FIG. 2, 5, or 7. Thus, the operations, features, and the achievable technical effects with respect to the method for recognizing an action described above are equally applicable to the apparatus 800 and the units contained therein, and details are not described herein.

According to an embodiment of the present disclosure, the present disclosure further provides an electronic device and a readable storage medium.

As shown in FIG. 9, FIG. 9 is a block diagram of an electronic device of the method for recognizing an action according to embodiments of the present disclosure. The electronic device is intended to represent various forms of digital computers such as a laptop computer, a desktop computer, a workstation, a personal digital assistant, a server, a blade server, a mainframe computer, and other appropriate computers. The electronic device may alternatively represent various forms of mobile apparatuses such as personal digital processing, a cellular telephone, a smart phone, a wearable device and other similar computing apparatuses. The parts shown herein, their connections and relationships, and their functions are only as examples, and not intended to limit implementations of the present disclosure as described and/or claimed herein.

As shown in FIG. 9, the electronic device includes: one or more processors 901, a memory 902, and interfaces for connecting various components, including high-speed interfaces and low-speed interfaces. The various components are interconnected using different buses and may be mounted on a common motherboard or otherwise as desired. The processor may process instructions executed within the electronic device, including instructions stored in or on the memory to display graphical information of a GUI on an external input/output apparatus, such as a display device coupled to the interface. In other embodiments, a plurality of processors and/or a plurality of buses may be used with a plurality of memories and a plurality of memories, if desired. Likewise, a plurality of electronic devices may be connected, each providing some of the necessary operations (e.g., as a server array, a set of blade servers, or a multiprocessor system). One processor 901 is used as an example in FIG. 9.

The memory 902 is a non-transitory computer readable storage medium provided by the present disclosure. The memory stores instructions executable by at least one processor, so that the at least one processor executes the method for recognizing an action provided by the present disclosure. The non-transitory computer readable storage medium of the present disclosure stores computer instructions, and the computer instructions are used to cause the computer to perform the method for recognizing an action provided by the present disclosure.

As a non-transitory computer readable storage medium, the memory 902 may be used to store non-transitory software programs, non-transitory computer-executable programs, and modules, such as program instructions/modules (for example, the acquisition unit 801, the construction unit 802, the first determination unit 803, and the recognition unit 804 shown in FIG. 8) corresponding to the method for recognizing an action in the embodiments of the present disclosure. The processor 901 executes various functional applications and data processing of the server by running the non-transitory software programs, instructions and modules stored in the memory 902, that is, implements the method for recognizing an action in the above method embodiments.

The memory 902 may include a stored program area and a stored data area, where the stored program area may store an operating system, an application program required by at least one function; and the stored data area may store data created according to the use of the electronic device for extracting a video clip, etc. Additionally, the memory 902 may include a high-speed random access memory, and may also include a non-transitory memory, such as at least one magnetic disk storage device, a flash memory device, or other non-transitory solid-state storage device. In some embodiments, the memory 902 may optionally include memories located remotely from the processor 901, and these remote memories may be connected to the electronic device for extracting a video clip via a network. Examples of such network include, but are not limited to, the Internet, an intranet, a local area network, a mobile communication network, and combinations thereof.

The electronic device of the method for recognizing an action may further include: an input apparatus 903, an output apparatus 904, and a bus 905. The processor 901, the memory 902, the input apparatus 903 and the output apparatus 904 may be connected via the bus 905 or in other ways, and the connection via the bus 905 is used as an example in FIG. 9.

The input apparatus 903 may receive input digital or character information, and generate key signal inputs related to user settings and function control of the electronic device of the method for extracting a video clip, such as touch screen, keypad, mouse, trackpad, touchpad, pointing stick, one or more mouse buttons, trackball, joystick and other input apparatuses. The output apparatus 904 may include a display device, an auxiliary lighting apparatus (for example, LED), a tactile feedback apparatus (for example, a vibration motor), and the like. The display device may include, but is not limited to, a liquid crystal display (LCD), a light emitting diode (LED) display, and a plasma display. In some embodiments, the display device may be a touch screen.

Various embodiments of the systems and technologies described herein may be implemented in digital electronic circuit systems, integrated circuit systems, dedicated ASICs (application specific integrated circuits), computer hardware, firmware, software, and/or combinations thereof. These various embodiments may include: being implemented in one or more computer programs that can be executed and/or interpreted on a programmable system that includes at least one programmable processor. The programmable processor may be a dedicated or general-purpose programmable processor, and may receive data and instructions from a storage system, at least one input apparatus, and at least one output apparatus, and transmit the data and instructions to the storage system, the at least one input apparatus, and the at least one output apparatus.

These computing programs (also referred to as programs, software, software applications, or codes) include machine instructions of the programmable processor and may use high-level processes and/or object-oriented programming languages, and/or assembly/machine languages to implement these computing programs. As used herein, the terms “machine readable medium” and “computer readable medium” refer to any computer program product, device, and/or apparatus (for example, magnetic disk, optical disk, memory, programmable logic apparatus (PLD)) used to provide machine instructions and/or data to the programmable processor, including machine readable medium that receives machine instructions as machine readable signals. The term “machine readable signal” refers to any signal used to provide machine instructions and/or data to the programmable processor.

In order to provide interaction with a user, the systems and technologies described herein may be implemented on a computer, the computer has: a display apparatus for displaying information to the user (for example, CRT (cathode ray tube) or LCD (liquid crystal display) monitor); and a keyboard and a pointing apparatus (for example, mouse or trackball), and the user may use the keyboard and the pointing apparatus to provide input to the computer. Other types of apparatuses may also be used to provide interaction with the user; for example, feedback provided to the user may be any form of sensory feedback (for example, visual feedback, auditory feedback, or tactile feedback); and any form (including acoustic input, voice input, or tactile input) may be used to receive input from the user.

The systems and technologies described herein may be implemented in a computing system that includes backend components (e.g., as a data server), or a computing system that includes middleware components (e.g., application server), or a computing system that includes frontend components (for example, a user computer having a graphical user interface or a web browser, through which the user may interact with the implementations of the systems and the technologies described herein), or a computing system that includes any combination of such backend components, middleware components, or frontend components. The components of the system may be interconnected by any form or medium of digital data communication (e.g., communication network). Examples of the communication network include: local area networks (LAN), wide area networks (WAN), the Internet, and blockchain networks.

The computer system may include a client and a server. The client and the server are generally far from each other and usually interact through the communication network. The relationship between the client and the server is generated by computer programs that run on the corresponding computer and have a client-server relationship with each other.

The method and apparatus for recognizing an action provided by the present disclosure: acquire the video clip and determine the at least two target objects in the video clip; for each target object in the at least two target objects, connecting the positions of the target object in the respective video frames of the video clip to construct the spatio-temporal graph of the target object; divide the at least two spatio-temporal graphs constructed for the at least two target objects into the plurality of spatio-temporal graph subsets, and determine the final subset from the plurality of spatio-temporal graph subsets; and determine the action category between target objects indicated by the relationship between the spatio-temporal graphs included in the final subset as the action category of the action included in the video clip, which may improve the accuracy of recognizing the action in the video.

The technique according to embodiments of the present disclosure solves the problem of inaccurate recognition of an existing method for recognizing an action in a video.

It should be understood that the various forms of processes shown above may be used to reorder, add, or delete steps. For example, the steps disclosed in the present disclosure may be executed in parallel, sequentially, or in different orders, as long as the desired results of the technical solutions mentioned in the present disclosure can be implemented. This is not limited herein.

The above specific implementations do not constitute any limitation to the scope of protection of the present disclosure. It should be understood by those skilled in the art that various modifications, combinations, sub-combinations, and replacements may be made according to the design requirements and other factors. Any modification, equivalent replacement, improvement, and the like made within the spirit and principle of the present disclosure should be encompassed within the scope of protection of the present disclosure.

1. A method for recognizing an action, comprising:
acquiring a video clip and determining at least two target objects in the video clip;
for each target object in the at least two target objects, connecting positions of the target object in respective video frames of the video clip to construct a spatio-temporal graph of the target object;
dividing at least two spatio-temporal graphs constructed for the at least two target objects into a plurality of spatio-temporal graph subsets, and determining a final subset from the plurality of spatio-temporal graph subsets; and
determining an action category between target objects indicated by a relationship between spatio-temporal graphs comprised in the final subset as an action category of an action comprised in the video clip.

2. The method according to claim 1, wherein the positions of the target object in the respective video frames of the video clip are determined by:
acquiring a position of the target object in a starting frame of the video clip, using the starting frame as a current frame, and determining the positions of the target object in the respective video frames through multi-rounds of an iterative operation; and
the iterative operation comprises:
inputting the current frame into a pre-trained prediction model to predict a position of the target object in a next frame of the current frame, and using, in response to determining that the next frame of the current frame is not an end frame of the video clip, the next frame of the current frame in a current round of the iterative operation as a current frame of a next round of the iterative operation;
in response to determining that the next frame of the current frame is the end frame of the video clip, stopping the iterative operation.

3. The method according to claim 1, wherein the connecting positions of the target object in respective video frames of the video clip comprises:
representing the target object as rectangular boxes in the respective video frames; and
connecting the rectangular boxes in the respective video frames according to a play order of the respective video frames.

4. The method according to claim 1, wherein the dividing at least two spatio-temporal graphs constructed for the at least two target objects into a plurality of spatio-temporal graph subsets comprises:
dividing adjacent spatio-temporal graphs in the at least two spatio-temporal graphs into a same spatio-temporal graph subset.

5. The method according to claim 1, wherein the acquiring a video clip comprises:
acquiring a video and dividing the video into video clips; and
the method comprises:
dividing spatio-temporal graphs of a same target object in adjacent video clips into a same spatio-temporal graph subset.

6. The method according to claim 1, wherein the determining a final subset from the plurality of spatio-temporal graph subsets comprises:
determining a plurality of target subsets from the plurality of spatio-temporal graph subsets; and
determining the final subset from the plurality of target subsets based on a similarity between each spatio-temporal graph subset in the plurality of spatio-temporal graph subsets and each target subset in the plurality of target subsets.

7. The method according to claim 6, wherein the method further comprises:
acquiring a feature vector of each spatio-temporal graph in the spatio-temporal graph subsets; and
acquiring relationship features among a plurality of spatio-temporal graphs in the spatio-temporal graph subsets,
wherein the determining a plurality of target subsets from the plurality of spatio-temporal graph subsets comprises:
clustering, by using a Gaussian mixture model, the plurality of spatio-temporal graph subsets based on feature vectors of the spatio-temporal graphs comprised in the spatio-temporal graph subsets and the relationship features among the spatio-temporal graphs comprised in the spatio-temporal graph subsets, and determining at least one target subset for representing each category of the spatio-temporal graph subsets.

8. The method according to claim 7, wherein the acquiring a feature vector of each spatio-temporal graph in the spatio-temporal graph subsets comprises:
acquiring a spatial feature and a visual feature of each spatio-temporal graph by using a convolutional neural network.

9. The method according to claim 7, wherein the acquiring relationship features among a plurality of spatio-temporal graphs in the spatio-temporal graph subsets comprises:
determining, for every two spatio-temporal graphs in the plurality of spatio-temporal graphs, a similarity between the two spatio-temporal graphs based on visual features of the two spatio-temporal graphs; and
determining a position change feature between the two spatio-temporal graphs based on spatial features of the two spatio-temporal graphs.

10. The method according to claim 6, wherein the determining the final subset from the plurality of target subsets based on a similarity between each spatio-temporal graph subset in the plurality of spatio-temporal graph subsets and each target subset in the plurality of target subsets comprises:
for each target subset in the plurality of target subsets, acquiring a similarity between each spatio-temporal graph subset and the target subset; and determining a maximum similarity in similarities between the spatio-temporal graph subsets and the target subset as a score of the target subset; and
determining a target subset with a highest score in the plurality of target subsets as the final subset.

11. An apparatus for recognizing an action, comprising:
at least one processor; and
a memory storing instructions, the instructions when executed by the at least one processor, cause the at least one processor to perform operations, the operations comprising:
acquiring a video clip and determine at least two target objects in the video clip;
connecting, for each target object in the at least two target objects, positions of the target object in respective video frames of the video clip to construct a spatio-temporal graph of the target object;
dividing at least two spatio-temporal graphs constructed for the at least two target objects into a plurality of spatio-temporal graph subsets, and determining a final subset from the plurality of spatio-temporal graph subsets; and
determining an action category between target objects indicated by a relationship between spatio-temporal graphs comprised in the final subset as an action category of an action comprised in the video clip.

12. The apparatus according to claim 11, wherein the positions of the target object in the respective video frames of the video clip are determined by:
acquiring a position of the target object in a starting frame of the video clip, using the starting frame as a current frame, and determining the positions of the target object in the respective video frames through multi-rounds of an iterative operation; and
the iterative operation comprises:
inputting the current frame into a pre-trained prediction model to predict a position of the target object in a next frame of the current frame, and using, in response to determining that the next frame of the current frame is not an end frame of the video clip, the next frame of the current frame in a current round of the iterative operation as a current frame of a next round of the iterative operation;
in response to determining that the next frame of the current frame is the end frame of the video clip, stopping the iterative operation.

13. The apparatus according to claim 11, wherein the connecting positions of the target object in respective video frames of the video clip comprises comprises:
representing the target object as rectangular boxes in the respective video frames; and
connecting the rectangular boxes in the respective video frames according to a play order of the respective video frames.

14. The apparatus according to claim 11, wherein the dividing at least two spatio-temporal graphs constructed for the at least two target objects into a plurality of spatio-temporal graph subsets comprises:
dividing adjacent spatio-temporal graphs in the at least two spatio-temporal graphs into a same spatio-temporal graph subset.

15. The apparatus according to claim 11, wherein the acquiring a video clip comprises:
acquiring a video and divide the video into video clips; and
the operations comprise:
dividing spatio-temporal graphs of a same target object in adjacent video clips into a same spatio-temporal graph subset.

16. The apparatus according to claim 11, wherein the determining a final subset from the plurality of spatio-temporal graph subsets comprises:
determining a plurality of target subsets from the plurality of spatio-temporal graph subsets; and
determining the final subset from the plurality of target subsets based on a similarity between each spatio-temporal graph subset in the plurality of spatio-temporal graph subsets and each target subset in the plurality of target subsets.

17. The apparatus according to claim 16, wherein operations further comprise:
acquiring a feature vector of each spatio-temporal graph in the spatio-temporal graph subsets; and
acquiring relationship features among a plurality of spatio-temporal graphs in the spatio-temporal graph subsets,
wherein the determining a plurality of target subsets from the plurality of spatio-temporal graph subsets comprises:
clustering, by using a Gaussian mixture model, the plurality of spatio-temporal graph subsets based on feature vectors of the spatio-temporal graphs comprised in the spatio-temporal graph subsets and the relationship features among the spatio-temporal graphs comprised in the spatio-temporal graph subsets, and determining at least one target subset for representing each category of the spatio-temporal graph subsets.

18. The apparatus according to claim 17, wherein the acquiring a feature vector of each spatio-temporal graph in the spatio-temporal graph subsets comprises:
acquiring a spatial feature and a visual feature of each spatio-temporal graph by using a convolutional neural network.

19. The apparatus according to claim 17, wherein the acquiring relationship features among a plurality of spatio-temporal graphs in the spatio-temporal graph subsets comprises:
determining, for every two spatio-temporal graphs in the plurality of spatio-temporal graphs, a similarity between the two spatio-temporal graphs based on visual features of the two spatio-temporal graphs; and
determining a position change feature between the two spatio-temporal graphs based on spatial features of the two spatio-temporal graphs.

20-21. (canceled)

22. A non-transitory computer readable storage medium, storing computer instructions which, when executed by a computer, cause the computer to perform operations, the operations comprising:
acquiring a video clip and determining at least two target objects in the video clip:
for each target object in the at least two target objects, connecting positions of the target object in respective video frames of the video clip to construct a spatio-temporal graph of the target object;
dividing at least two spatio-temporal graphs constructed for the at least two target objects into a plurality of spatio-temporal graph subsets, and determining a final subset from the plurality of spatio-temporal graph subsets; and
determining an action category between target objects indicated by a relationship between spatio-temporal graphs comprised in the final subset as an action category of an action comprised in the video clip.
